(19) United States
(12) Patent Application Publication
(10) Pub. No.: US 2001/0043679 A1
(43) Pub. Date: Nov. 22, 2001

(54) VOICE MAIL SYSTEM WITH SUBSCRIBER NOTICEBOARD FACILITY

(76) Inventors: PHILIP BLAKE, HAMPSHIRE (GB); LAWRENCE LEON PORTER, HAMPSHIRE (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 09/074,454

(22) Filed: May 6, 1998

(30) Foreign Application Priority Data
May 6, 1997 (GB) 9709186.2

(51) Int. Cl. H04M 1/64; H04M 11/00

(52) U.S. Cl. 379/67.1; 379/88.18

(57) ABSTRACT

A voice mail system has a set of mailboxes. A caller can then leave a message in the appropriate mailbox for the voice mail system subscriber that they were trying to contact. Normally when such a caller first reaches a mailbox, they hear a personalised greeting from the subscriber. It is difficult for the subscriber to keep the greeting brief yet informative. The present invention provides the subscriber with an additional noticeboard on which to record further information. A caller can gain access to this noticeboard by pressing an appropriate DTMF key whilst listening to the greeting. More sophisticated systems can have a hierarchy of noticeboards, with the top one providing menu information, and allowing a caller to select the noticeboard of most relevance to them. The subscriber can password-protect individual noticeboards, so that they can only be accessed by properly authorised callers.

### BACKGROUND OF THE INVENTION

The present invention relates to voice mail systems, and in particular to the way in which such voice mail systems can provide information to callers.

Voice mail systems (also termed voice messaging systems) are very well-known in the art, and are used to store messages from incoming calls when the intended recipient is absent or otherwise engaged. The intended recipient (often referred to as a subscriber to the voice mail system) can then listen to their stored messages at some future time.

A voice mail system is generally implemented either on special purpose computer hardware, or else on a standard computer workstation equipped with a suitable telephony interface. This system is then attached to (or into) the telephone network, typically via a switch or PBX. Such voice mail systems are well-known; one example is the DirectTalkMail system, available from IBM Corporation, which operates in conjunction with the DirectTalk/6000 voice processing system (also available from IBM). Other examples of voice mail systems are described in U.S. Pat. No. 4,811,381 and EPA 0588576.

An important feature of many voice mail systems is their ability to provide callers with a personalised greeting for the intended recipient. Typically such greeting is actually a message recorded by the subscriber, which is then played to the caller. This message or greeting might simply state “You have reached the voice mailbox of Larry Porter. I am sorry I am not available at present. Please leave a message after the tone”.

More sophisticated voice mail systems allow the caller to input a dual tone multiple frequency (DTMF) tone. This is then recognised by the voice mail system, and the requested action performed. Often, this may involve transferring the caller to another extension. For example, one possible greeting using the above-mentioned DirectTalkMail system might be:

“You have reached the voice mailbox of Larry Porter. I am out of the office on business travel until Thursday 5th July. I should have occasional access to my voice mail messages. You may press 5 to transfer to my secretary, or press 0 to transfer to the switchboard. Otherwise, please leave a message after the tone and I will respond as soon as possible.”

Another feature of the DirectTalkMail voice mail system is that a subscriber may have two or more greetings, and designate one as the current greeting. This is useful for example to allow a subscriber to have one standard greeting for when they are in the office, and a different greeting when they are out of the office (eg on holiday, or on business travel). The subscriber can then swap between greetings as appropriate, rather than having to re-record a new greeting each time they leave or return to the office.

It is also possible to specify a greeting header and a greeting body separately. This is useful for example to allow the greeting header to state the current date (to re-assure the caller that the subscriber is indeed in the office), followed by a greeting body giving a list of possible contact options. A subscriber can then update the greeting header on a daily basis, but only update the greeting body if and when appropriate. Note that from the system point of view, the greeting header and greeting body are two separate but associated greetings, which are automatically played in succession, one after the other.

It is further possible to designate a greeting as an announcement only. This plays a greeting (announcement) to the caller in the normal manner, but does not allow them the opportunity to leave a voice mail message. This facility is useful for example during a prolonged absence, when that voice mailbox will not be monitored.

It will be noted that the greeting quoted above is rather long. The DirectTalkMail voice system allows another option to be presented to the caller: “Press # to skip the rest of this greeting”. This can be useful for callers who are already familiar with this voice mail system and greeting, but at the same time represents yet a further increase in the duration of the greeting.

In general, a subscriber must strike a delicate balance between keeping their greeting reasonably brief, yet providing the caller with sufficient information. This is especially difficult, given that a subscriber may be contacted by a wide range of callers having different requirements. For example, the caller may be a business colleague, who simply wants to leave a message and already knows how to transfer calls etc (since he or she uses the same voice mail system). Alternatively, the caller may be a potential new customer, in which case it is desirable to be able to allow them to be easily routed to a live person. Another possibility is that it is a personal call, and the caller is mainly interested in knowing whether there is a current contact number for the subscriber. In current voice mail systems it is rather difficult for a user to provide a greeting that reconciles the needs of all the different types of potential callers.

### SUMMARY OF THE INVENTION

Accordingly, the invention provides a method of operating a voice mail system supporting multiple subscribers comprising the steps of:

storing a noticeboard containing information associated with a subscriber;

receiving a call for the subscriber;

playing a greeting to the caller; and

playing the noticeboard information to the caller, responsive to the caller performing a predetermined action.

The use of the noticeboard provides a solution to the dilemma of making a subscriber greeting brief but informative. Thus the approach described herein allows the information contained in the greeting to be kept to a minimum, with additional information being stored separately in the noticeboard. The caller does not receive the noticeboard information by default, so the additional information is only provided to callers who make a specfic request for it. By contrast, callers who simply want to leave a message, or perhaps who already know the information in the noticeboard, can easily avoid listening to the noticeboard, and thereby reduce the time they spend on the telephone to the subscriber's voice mail system.

In the preferred embodiment said predetermined action comprises the caller inputting a DTMF key, typically whilst the greeting is being played (or perhaps shortly after it has terminated), although the predetermined action might also represent some voice input, if the voice mail system includes a speech recognition capability. Also, in the preferred embodiment, the method further comprises the initial step of recording audio input from said subscriber into the noticeboard. Thus a subscriber can input information into the noticeboard in essentially the same manner as recording a greeting. Note however that an alternative possibility is to import text for all or part of the noticeboard information, providing the voice mail system includes a text-to-speech conversion facility for subsequently playing out this text to a caller.

Preferably the voice mail system stores two or more noticeboards for at least one subscriber (the number of noticeboards need not be the same for all subscribers). One possibility is for a subscriber then to select one of their noticeboards as the current one to be played to callers, responsive to the callers performing said predetermined action. More complex arrangements are also possible, for example where noticeboards are concatenated together.

In a preferred embodiment, the two or more noticeboards can be accessed from a menu, wherein the menu is played to the caller responsive to the caller performing said predetermined action. Information from the first or second noticeboard is then played to the caller, responsive to the caller performing a subsequent predetermined action. Typically the caller performs the subsequent predetermined action by inputting another DTMF key to access the noticeboard containing information of particular interest to them. Note that this further increases the selectivity of the information. Thus callers can just listen to the information of interest to them, without at the same time being forced to listen to a large amount of irrelevant information. In a slight variation on the above arrangement, the menu itself can comprise a noticeboard, again providing the caller with a choice of further noticeboards containing different information (in principle it would be possible to extend this hierarchy further to additional levels, but this is likely to be overly confusing for both the caller and subscriber).

It is further preferred that at least one of said two or more noticeboards is password-protected, such that responsive to the caller performing said predetermined action, the method comprises the steps of:

prompting the caller to enter a password;

receiving a password from the caller; and

playing the information from said at least one password-protected noticeboard to the caller, only if the caller has entered the correct password.

The use of password protection further aids in the power and flexibility of the system, since a subscriber can now use a noticeboard to store confidential or personal information, knowing that this information can only be accessed by a properly authorised caller (ie one to whom they have given the password). One possibility for example is to record commercially sensitive information on the noticeboard, where it is important that this information is easily accessible to the subscriber's colleagues (who have the password), but is inaccessible to general callers (who do not have the password).

Note that password protection could also be employed even where only a single noticeboard is being used, although this might appear somewhat unfriendly to general callers, who would therefore be unable to access any information on the noticeboard at all.

In the preferred embodiment, the method further comprises the step, subsequent to playing all the noticeboard information to the caller, of offering the caller the choice of returning to the top of the noticeboard, or to the subscriber greeting. These are generally the most convenient choices to offer to the caller, although of course it may be appropriate in some applications to offer further or different choices (such as a transfer to the switchboard), or to have some action which is performed automatically (such as a return to the greeting). It might also be desirable in some situations to allow each subscriber, potentially on a per noticeboard basis, to specify the action to be taken after a caller has listened to all of the noticeboard, or to customize the choices available to callers after they have listened to the noticeboard.

The invention further provides a voice mail system supporting multiple subscribers comprising:

means for storing a noticeboard containing information associated with a subscriber;

means for receiving a call for the subscriber;

means for playing a greeting to the caller; and

means for playing the noticeboard information to the caller, responsive to the caller performing a predetermined action.

### DETAILED DESCRIPTION

A preferred embodiment of the present invention will now be described in detail by way of example only with reference to the following drawings:

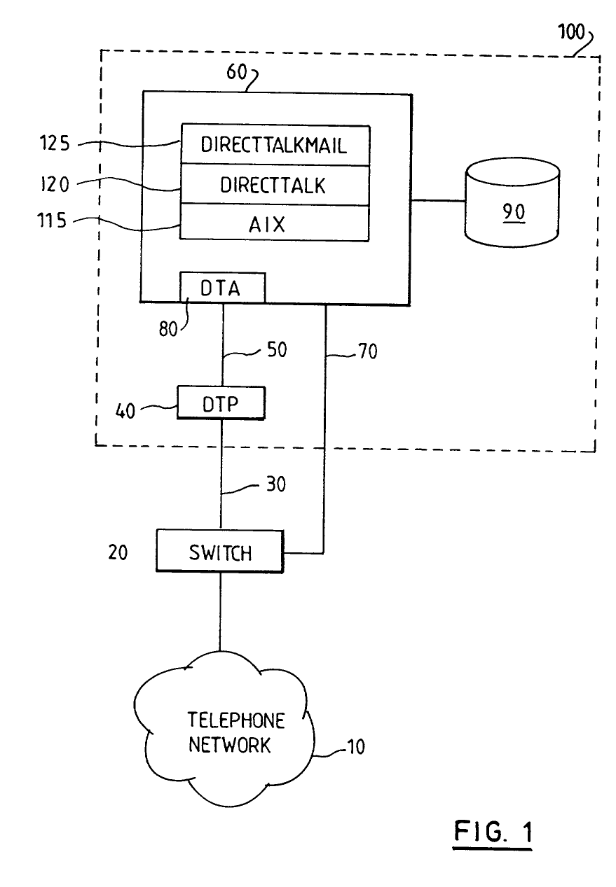

FIG. 1 depicts a voice mail system;

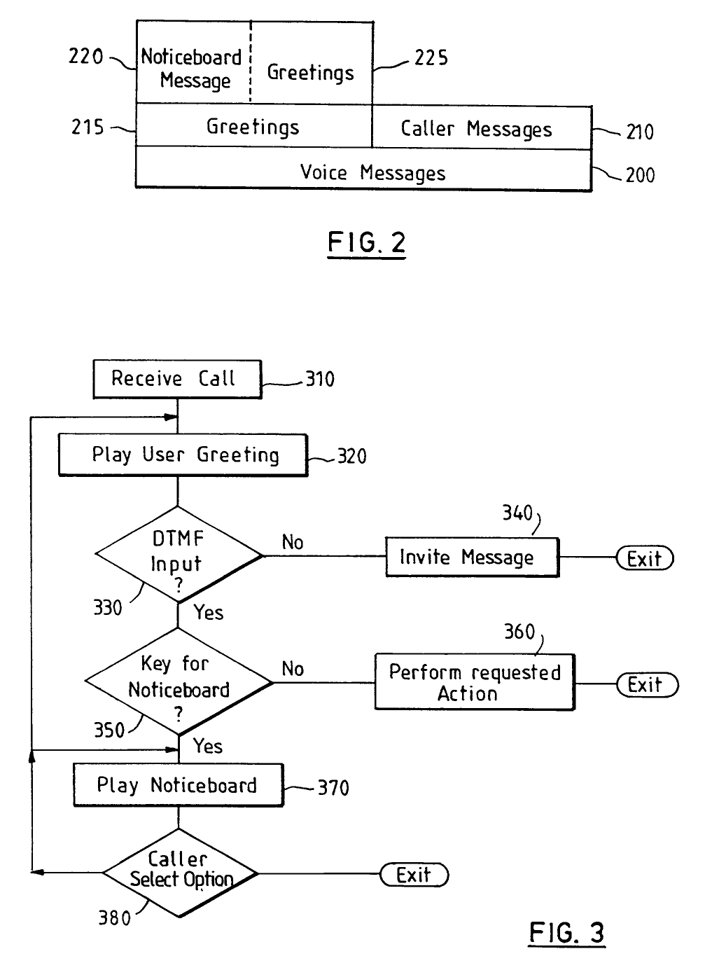

FIG. 2 illustrates the relationship between caller messages, greetings, and the noticeboard; and

FIG. 3 is a flow chart illustrating call handling involving the noticeboard.

FIG. 1 is a simplified diagram of a voice mail system 100, based on a conventional computer workstation, shown as system unit 60, and including disk storage unit 90 for storing voice messages. The voice mail system is attached to the telephone network 10 via a switch 20, and one or more digital trunk lines 30, such as a T1 or E1 digital trunk line. The voice mail system includes a digital trunk processor 40 to terminate the incoming digital trunk lines, which in turn is attached to a digital trunk adapter 80 in the system unit via link 50. The digital trunk processor is used to demultiplex incoming signals and multiplex outgoing signals on the trunk line, and perform log-linear conversion as appropriate. The digital trunk processor is also used to perform compression/decompression and to recognise incoming DTMF tones.

In some embodiments an additional link 70 may be provided between the switch and the voice processing system to exchange signalling information between the switch and the voice mail system. For example, if the switch transfers a call from an internal extension to the voice mail system, it can use this link to inform the voice mail system of the internal extension to which the call was originally directed. This allows the voice mail system to play the greeting for the subscriber who owns that internal extension. Alternatively, it is possible to provide some of this signalling information over the digital trunk line(s) 30.

The voice mail system illustrated in FIG. 1 is based on the DirectTalk/6000 voice processing system, available from IBM Corporation, which in turn is implemented upon an RISC System/6000 computer workstation, plus the digital trunk processor and digital trunk adapter. The main software components of this voice mail system comprise the AIX operating system 115, on top of which runs the DirectTalk voice processing program 120. This in turn provides an application programming interface (API) (or more accurately, several different APIs), to allow user applications to perform functions such as play voice prompts, store voice messages, and so on. The DirectTalkMail program 125 is then an application which runs on top of the DirectTalk voice processing program to provide voice messaging capabilities. Thus the DirectTalkMail voice messaging system contains routines to allow callers to telephone messages into the system and and to allow subscribers to subsequently extract these messages for listening to.

Further details about the DirectTalk/6000 voice processing system and designing applications therefor, such as playing prompts, recording messages, and processing DTMF inputs, can be found in the manual “IBM AIX DirectTalk/6000, General Information and Planning” (publication number GC33-1720-00) and the other manuals referenced therein; the DirectTalkMail voice mail system is described in particular in “IBM AIX DirectTalk/6000 DirectTalkMail Adminstration” publication reference SC33-1733).

It will be appreciated that voice mail systems such as that illustrated in FIG. 1 are well-known, and that the skilled person would be aware of many variations on the system illustrated. For example, there are systems in which telephone line 30 is analog; in some systems the separate digital trunk processor is often omitted, and its functions performed by a suitable telephony adapter card. In addition, the voice mail system may be connected directly to the telephone network (ie without a switch), or perhaps even form part of the telephone network itself, to allow the telephone network provider to offer a voice mail service. The voice mail system may also include other known components, such as an audio capture/playback card, network interface card, and so on (not shown). The precise hardware configuration employed in the voice mail system is not relevant to an understanding of the present invention, and so will not be discussed further. Similarly, the standard operation of a voice mail system is well-known in the art, and so only those aspects pertinent to an understanding of the present invention will now be described.

The DirectTalkMail voice messaging system can be considered as a form of database system, based on mailboxes. Thus each user or subscriber has a mailbox, which has associated with it a user profile which includes all the information for that user, eg their extension number, their password, the number of new messages that they have, their current greeting, and so on. The mailbox also logically contains the digitised stored messages for that subscriber (although physically the audio recording may be stored in a different location from the other information). Each mailbox has a unique identifier, such as a number or name; in the preferred embodiment, each mailbox is allocated the extension number of the subscriber associated with that mailbox.

FIG. 2 illustrates a logical hierarchy of voice message storage within the voice mail system. At the lowest level are simple voice messages 200. Thus the DirectTalk voice processing system provides predefined actions for creating (ie recording) voice messages, for playing (ie listening to) such voice messages, and so on.

Within a user mailbox, these voice messages are subdivided into two categories, those voice messages left by callers 210, and those voice messages created by the subscriber him/herself to act as greetings 215. It will be appreciated that the DirectTalkMail system treats greetings in a different manner from caller messages. For example, the DTMF key for “0” may be active whilst a greeting is being played to transfer to the switchboard, but not whilst playing a caller message. In addition, the voice mail system stores appropriate information in conjunction with each greeting and caller message in a mailbox. For example, for caller messages the system stores the time and date that the call was received. Further, out of the list of greetings, one will be identified as the current greeting, whilst for caller messages, the system will maintain a list of which are new messages, and which are old messages (ie which messages the subscriber has or has not listened to as yet).

Finally, in accordance with the present invention, the greeting category is further subdivided into normal greetings 225, and a noticeboard 220. The former correspond to the conventional greetings played to a caller, these usually being personalised for the mailbox concerned. As previously mentioned, the DirectTalkMail system allows a subscriber to store multiple greetings. Therefore, the system stores an identification number with each greeting, with one particular greeting being designated as the current greeting.

The noticeboard, which is not provided in prior art voice mail systems, offers a subscriber an opportunity to record additional information which may be of interest to the caller. This information is separate from the greeting, but the caller may access the noticeboard by pressing a preselected key whilst listening to the greeting. For example, a greeting may now state:

“You have reached the voice mailbox of Larry Porter. I am out of the office on vacation until Monday 8th August and will not have access to my voice mail messages. You may press 0 to transfer to the switchboard, or press 6 to access further information on my noticeboard. Otherwise, please leave a message after the tone and I will respond as soon as possible.”

If the caller selects to listen to the noticeboard, by pressing DTMF key 6, then the voice mail system responds by playing out to the caller the pre-recorded noticeboard, which might for example have the following information:

“For information concerning DirectTalkMail marketing, please contact our US sales department on telephone number 123 456 7890, or see our Web page at WWW.DIRECTTALKMAIL.COM//MARKETING. For information on the Industry Voice Mail Forum working party status on Java telephony, please refer to the Web page WWW.DIRECTTALKMAIL.COM//IVMF . . . ”

In other words, the noticeboard allows for a subscriber to provide callers with the opportunity to access detailed information, without cluttering up with excessive detail the greeting that is automatically played to all callers. Rather, the noticeboard allows callers to selectively access if and when they require it. (It will be appreciated that the term “noticeboard” for this facility is somewhat arbitrary, and the feature could be called “information board”, “audio factfile” or anything else appropriate).

The noticeboard information is stored within the voice mail system effectively as a greeting, but is assigned a predetermined identification number, or from a predetermined range of greeting numbers, so that the system knows that it represets a noticeboard rather than another greeting. Creation and maintenance of the noticeboard is straightforward and is analogous to corresponding operations on greetings. Thus whereas conventional systems allow subscribers to record or change a greeting, the voice mail system of the present invention offers subscribers the additional option of recording or changing their noticeboard. This is effected by the subscriber recording an appropriate voice message into the DirectTalk voice processing system, and the DirectTalkMail application then updating the user profile in the voice mailbox to indicate the new or updated noticeboard.

Playout of the noticeboard to a caller in the preferred embodiment is illustrated in the flow-chart of FIG. 3. The voice mail system initially receives a call (step 310) and plays the greeting for the called subscriber (step 320). During the playing of the greeting, the voice mail system monitors the telephone line for DTMF inputs from the caller (step 330). If no such input is received, the caller then has the opportunity to leave a message for the subscriber (step 340). Alternatively, if a DTMF input is received, the voice mail system checks to see whether the input key corresponds to transfer to the noticeboard (step 350) (nb the voice mail system preassigns a particular DTMF key to represent transfer from a greeting to the noticeboard). Assuming that the relevant key for such transfer was indeed requested, the voice mail system then retrieves the stored voice message corresponding to the noticeboard, and plays this to the caller (step 370). Once the noticeboard has completed, the system then prompts the caller (step 380) to return to the top of the noticeboard, to return to the greeting, or to exit (hang up). The caller selects a desired option by inputting an appropriate DTMF key, and the voice mail system then performs the requested action. Returning now to step 350, if the DTMF key corresponds to some action other than access to the noticeboard (eg transfer to the switchboard), then the voice mail system takes whatever action is appropriate (step 360).

It will be appreciated that the flow chart of FIG. 3 represents a simple example only, and many variations are possible. For example, as previously mentioned, it is possible to configure a DTMF key to skip the remainder of the subscriber greeting and go straight to the message prompt; in the context of FIG. 3 this represents performing step 340 after step 360. As another example, the caller might automatically be transferred to the switchboard after listening to the full noticeboard. Further, the greeting originally played to the caller in step 320 might be provided as a standard by the system (ie the same for all callers), leaving each subscriber with only their noticeboard to personalise.

Whilst listening to the noticeboard, certain DTMF keys are active to assist the caller in using the information contained in it. In particular, in the preferred embodiment DTMF keys 7, 8 and 9 can be used to skip backwards, pause, and skip forwards in the noticeboard respectively. In the DirectTalkMail system these same keys have an equivalent function when listening to a caller message. (The skilled person will be aware of many other possible assignments for the DTMF keys whilst listening to a noticeboard).

The noticeboard so far described represents a relatively basic implementation, with only a single notice board. However, this principle can be readily developed to allow multiple noticeboards. One approach would be to swap between noticeboards to specify the current noticeboard, in the same way that one can select the current greeting from multiple stored greetings. Also, it may be possible to concatenate noticeboards, again analogous to using greeting headers and bodies.

However, a preferred embodiment adopts a more sophisticated nested structure of noticeboards, in which there is a menu which gives access to multiple lower level noticeboards. For example, the top level menu might be:

“For contact information, including my email id, and secretarial support, press 1;

For information on the forthcoming DirectTalkMail user group meeting, press 2;

For an update on the Lotus installation problem, press 3 . . . ”

This menu would then be played to the caller in response to the caller selecting the noticeboard option from the greeting. The caller could then press a further key, to access one of the lower level noticeboards according to the different menu options.

The creation of the menu proceeds as follows. The voice mail system initially asks the subscriber to select a menu number, which they do by pressing a DTMF key. The subscriber is then asked to record the noticeboard corresponding to this number. Next, the subscriber is asked to record a menu item to be associated with this noticeboard, in other words, something analogous to the “For contact information, including my email id, and secretarial support, press 1” presented above. Optionally, the subscriber may be finally asked to select a default action to occur at the end of the noticeboard, from a set of possible actions (such as returning to the greeting, switching to a switchboard operator, and so on); other options include presenting the caller with a list of options, or the system performing some default action automatically.

In this embodiment, when a caller chooses to access the noticeboard from a greeting, the voice mail system concatenates the set of available menu items recorded as above, so that effectively they sound continuous to the caller, and subsequently plays the noticeboard as selected by the caller.

As a slight variation on the above, it is possible to create a top-level noticeboard representing the menu. This leads to the creation of a simple noticeboard hierarchy which can be largely modelled on the creation of multiple greetings. For example, noticeboard “0” could be conventionally regarded as the top level menu (ie the one that is directly accessed from the greeting). This can then be created in analogous fashion to the other noticeboards (except that the voice mail system knows that when playing this top-level noticeboard, various DTMF keys are active to access the lower level noticeboards). Note that with this approach, the subscriber would not record menu items separately with each lower level noticeboard. Having the top level menu as a noticeboard increases flexibility somewhat, but also makes management of the noticeboards more difficult for a subscriber (for example, if they wish to delete a noticeboard from the menu, they are required to access both the noticeboard itself, plus the menu noticeboard).

A further enhancement is to allow the subscriber the option of assigning a password to one or more noticeboards. Thus after each noticeboard is updated or created, the subscriber is asked whether or not they wish to password protect that noticeboard, and if so, to enter the relevant password, which is stored in association with the noticeboard (the password will generally not be the same for the different noticeboards). Subsequently, before playing a noticeboard to a caller, the voice mail system checks to see if it is password protected, and if so, will prompt the caller for the password. The noticeboard is then only played to the caller providing that they can enter the correct password.

The use of passwords is particularly advantageous when it is desired to make information on the noticeboard accessible to a selected group of callers only. For example, a subscriber may desire to put a message on a noticeboard for his or her spouse: “Hi I'm sorry I'm having to work late tonight, but I'll buy a pizza on the way home. See you about nine”. Another possibility is that a subscriber may put up a noticeboard containing confidential information about a sales bids. His or her colleagues can then access this information providing they have the correct password, but it is not accessible to general callers.

Note that a simpler but less secure method of protecting noticeboard information would be to record a noticeboard, but not to explicitly mention it in the menu. Thus for example a spouse might know that any information for them would always be stored in the noticeboard accessed by pressing key 6; however, the top-level noticeboard would not actually list this as a possible option.

It will be appreciated that there are many possible variations on system outlined above. Thus the range and function assignment of DTMF keys for different messages is highly flexible, and can be tailored according to application needs. For example, in some situations it may be desirable to allow DTMF key 0 to transfer to the switchboard from anywhere within a noticeboard. Note that in the present embodiment, the assignment of DTMF keys is controlled by the system. Nevertheless, this still leaves the user with some flexibility; for example, from a normal greeting, pressing DTMF key 5 transfers the call to a user-specified extension. Clearly it would be possible to include and extend this approach with respect to noticeboards offering transfers to multiple different extensions (perhaps by the caller inputting “*1”, “*2”, etc, as appropriate). Of course, in principle, one could permit subscriber assignment of DTMF keys, although in practice this would probably overburden most users.

Other possible variations include the use of speech recognition to accept spoken digits as an alternative to the caller pressing the corresponding DTMF key in order to navigate through the voice mail system and application menus. Moreover, a more sophisticated system could be developed, allowing the caller to speak specific commands, such as “noticeboard”, with the system then responding accordingly. Similarly, the subscriber need not necessarily record (ie speak) their noticeboard entry; rather, they might simply provide a text entry, and the voice mail system would then perform a text to speech conversion when a caller tried to listen to the noticeboard contents. In this manner the noticeboard might perhaps link to a computer diary system, to provide callers with information on the currrent schedule of the subscriber. The use of speech recognition and text-to-speech conversion in conjunction with voice processing systems is well-known in the art (see the above-referenced DirectTalk manuals).

1. A method of operating a voice mail system supporting multiple subscribers comprising the steps of:
storing a noticeboard containing information associated with a subscriber;
receiving a call from a caller and information identifying a particular subscriber;
playing a greeting to the caller;
playing the noticeboard information associated with said particular subscriber to the caller, responsive to the caller performing a predetermined action.

2. The method of claim 1, wherein said predetermined action comprises the caller inputting a DTMF key.

3. The method of claim 2, wherein said DTMF key is input whilst the greeting is being played.

4. The method of claim 3, wherein said greeting is personalised for said particular subscriber.

5. The method of claim 1, wherein said greeting is personalised for said particular subscriber.

6. The method of claim 1, further comprising the step of recording audio input from said subscriber into the noticeboard.

7. The method of claim 1, wherein said storing step comprises including text information in the noticeboard, and said playing step includes performing a text-to-speech conversion on said text information.

8. The method of claim 7, wherein said greeting is personalised for said particular subscriber.

9. The method of claim 1, wherein two or more noticeboards are stored for at least one subscriber.

10. The method of claim 9, wherein said at least one subscriber can designate one of the two or more noticeboards as their current noticeboard, such that the information from the current noticeboard is played to the caller, responsive to the caller performing said predetermined action.

11. The method of claim 9, wherein said two or more noticeboards can be accessed from a menu, wherein said menu is played to the caller, responsive to the caller performing said predetermined action, and information from said first or second noticeboard is played to the caller, dependent on the caller performing a subsequent predetermined action.

12. The method of claim 11, wherein at least one of said two or more noticeboards is password-protected, such that responsive to the caller performing said predetermined action, the method comprises the steps of:
prompting the caller to enter a password;
receiving a password from the caller; and
playing the information from said at least one password-protected noticeboard to the caller, only if the caller has entered the correct password.

13. The method of claim 1, wherein said noticeboard is password protected.

14. The method of claim 1, further comprising the step, subsequent to playing all the noticeboard information to the caller, of offering the caller the choice of returning to the top of the noticeboard, or to the caller greeting.

15. A voice mail system supporting multiple subscribers comprising:
means for storing a noticeboard containing information associated with a subscriber;
means for receiving a call from a caller and information identifying a particular subscriber;
means for playing a greeting to the caller; and
means for playing the noticeboard information associated with said particular subscriber to the caller, responsive to the caller performing a predetermined action.
